(19) United States
(12) Patent Application Publication
(10) Pub. No.: US 2013/0098893 A1
(43) Pub. Date: Apr. 25, 2013

(54) Portable liquid warmer

(71) Applicant: Randall Soule, Reno, NV (US)

(72) Inventor: Randall Soule, Reno, NV (US)

(21) Appl. No.: 13/317,724

(22) Filed: Oct. 25, 2011

(51) Int. Cl. F27D 11/00

(52) U.S. Cl. 219/441

(57) ABSTRACT

An apparatus for warming consumable liquids and for controllably maintaining the elevated temperature of the liquid that includes a housing having an upper portion, a tapered lower portion and a side wall defining a tapered receiving chamber for receiving the container containing the consumable liquid. Disposed within the housing in close proximity to the tapered receiving chamber is an electric heater for heating the receiving chamber. Operably associated with the electric heater is a controller that includes an electrical circuit for energizing the electric heater and for controllably maintaining the electric heater at a selected one of a plurality of elevated temperatures.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to warmers for warming consumable liquids, such as coffee, and for controllably maintaining the elevated temperature of the liquid. More particularly, the invention concerns a warmer for warming consumable liquids and for maintaining the temperature of the liquid at one of three temperatures selected by the user.

2. Description of Related Art Including Information Disclosed Under 37 CFR 1.97 and 1.98

Beverages such as coffee, tea and the like are best enjoyed when consumed hot. When such beverages are served in a conventional drinking cup they tend to cool relatively rapidly. This is particularly true when the beverage is served in a paper drinking cup of the character used in many drive-through restaurants.

Devices of several different designs have been suggested in the past for warming consumable liquids and for maintaining the elevated temperature of the liquid. Exemplary of one such device is that described in U.S. Pat. to Dam No. 6,121,585. The invention described in the Dam patent comprises a beverage cup and cupholder system. The Dam beverage cup includes a sleeve, a liner and a base that includes a plate, a heating element and a pair of spring terminals. The base further includes a contact ring and a contact disk. The cupholder, which is adapted to mate with the base of the beverage cup, has recessed land areas which lie below a plane of the support for the beverage cup and are electrically isolated from each other. The cupholder includes spring contacts which extend into the recessed land areas and are adapted to receive connections from an external source of electrical current. The beverage cup, when filled with a hot beverage, is placed into the cupholder. As the beverage cup is placed into the cupholder, the contact disk and contact ring automatically align with the recessed land areas and make contact with the spring contacts. The heating element of the device maintains a beverage at a desirable equilibrium temperature for an extended period of time.

Another prior art device past for warming consumable liquids is described in U.S. Pat. No. 4,463,664 issued to Peace. The Peace invention provides a receptacle having a thermally nonconductive exterior to retain the heat of liquids, and a durable heat-conductive interior portion to reside in heat-conductive relation with a source of warming heat, so as to impart heat to the contents of the receptacle. The receptacle of the Peace device comprises a heat-conductive liner including a bottom portion and an upwardly extending wall portion, and a heat-insulating sleeve surrounding the wall portion of the liner, the bottom portion of the liner being exposed for direct contact with a heat source. The nonconductive sleeve surrounding the wall portion of the conductive liner has an open bottom which terminates a short distance below the bottom portion of the liner in surrounding yet spaced-apart relation to the bottom portion, in order to isolate the sleeve from the heat source.

### BRIEF SUMMARY OF THE INVENTION

By way of brief summary, one form of the apparatus of the present invention for warming consumable liquids and for controllably maintaining the elevated temperature of the liquid comprises a housing having an upper portion, a tapered lower portion and a side wall defining a tapered receiving chamber for receiving the container containing the consumable liquid. Disposed within the housing in close proximity to the tapered receiving chamber is an electric heater for heating the receiving chamber. Operably associated with the electric heater is a controller that includes an electrical circuit for energizing said electric heater and for controllably maintaining the electric heater at a selected one of a plurality of elevated temperatures.

With the foregoing in mind, it is an object of the present invention to provide an apparatus for warming consumable liquids and for maintaining the elevated temperature of the liquid that uniquely includes a heating mechanism that will maintain the temperature of the liquid at one of three temperatures selected by the user.

Another object of the invention is to provide an apparatus of the aforementioned character which will consistently maintain hot drinks at the desired elevated temperature when a user is traveling in a vehicle or is at any location where there is a 12 VDC or 120 VAC power source.

Another object of the invention is to provide an apparatus of the character described in which the tapered receiving chamber of the device will receive paper take-out containers of virtually every size and will effectively hold the container in a stable, readily accessible position.

Another object of the invention is to provide an apparatus of the class described which is designed and sized to allow the user to remove the container from the tapered receiving chamber of the device in order to drink the consumable liquid, or alternatively, to leave the container in the tapered receiving chamber and drink the consumable liquid while holding the device with the container still positioned within the tapered receiving chamber.

Another object of the invention is to provide an apparatus of the character described in the preceding paragraphs which is designed and constructed in a manner that makes it fully compliant with Underwriter Laboratories (UL), ETL Testing Laboratories (now Intertek Testing Services) (ETL) and like nationally recognized testing laboratories approval requirements.

Another object of the invention is to provide an apparatus of the aforementioned character in which, for safety purposes, the controller of the device will de-energize the electric heater after the electric heater reaches a predetermined elevated temperature.

Another object of the invention is provide an apparatus of the character described in which the controller of the device will de-energize said electric heater after the expiration of a predetermined time following the energization of the heater.

Another object of the invention is provide an apparatus of the character described in which the device has three preset temperature settings of low, medium and high and in which the device housing is provided with three small “coffee bean” shaped lights which indicate the temperature setting selected.

Another object of the invention is provide an apparatus of the character described that is attractive in appearance, is inexpensive to manufacture and is easy to use.

The foregoing objectives as well as other features and advantages of the present invention will become readily apparent from the following detailed description and the accompanying drawings.

### BRIEF DESCRIPTION OF SEVERAL VIEWS OF THE DRAWINGS

FIG. 1 is a generally perspective, exploded view of one form of the apparatus of the invention for warming consumable liquids and for maintaining the elevated temperature of the liquid.

FIG. 2 is a right side view of the apparatus shown in FIG. 1.

FIG. 3 is a left side view of the apparatus shown in FIG. 1.

FIG. 4 is a generally perspective, exploded view of the apparatus of the invention illustrating the positioning of the controller assembly of the apparatus on the device housing.

FIG. 5 is a cross-sectional view taken along lines 5-5 of FIG. 4

FIG. 5A is a generally perspective, fragmentary view of the apparatus shown in FIG. 5 illustrating the interconnection of the controller with the heating member.

FIG. 6 is a cross-sectional view taken along lines 6-6 of FIG. 1.

FIG. 7 is a block diagram of the electrical circuitry of one form of the apparatus of the invention.

### DETAILED DESCRIPTION OF THE INVENTION

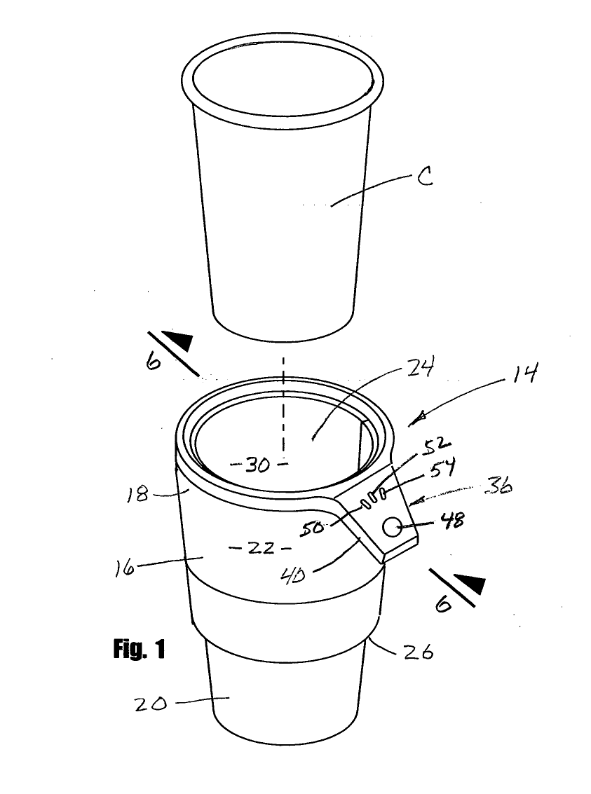

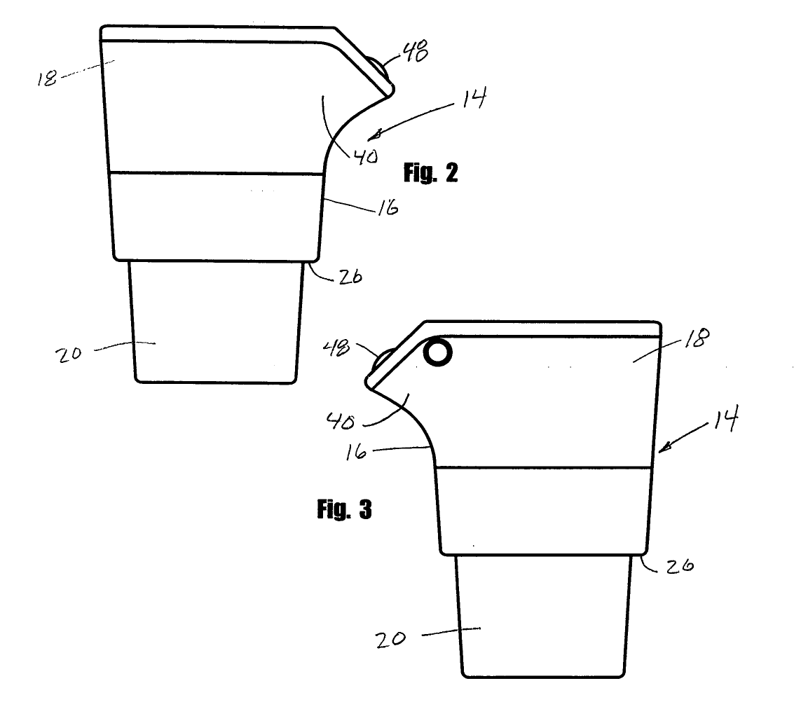

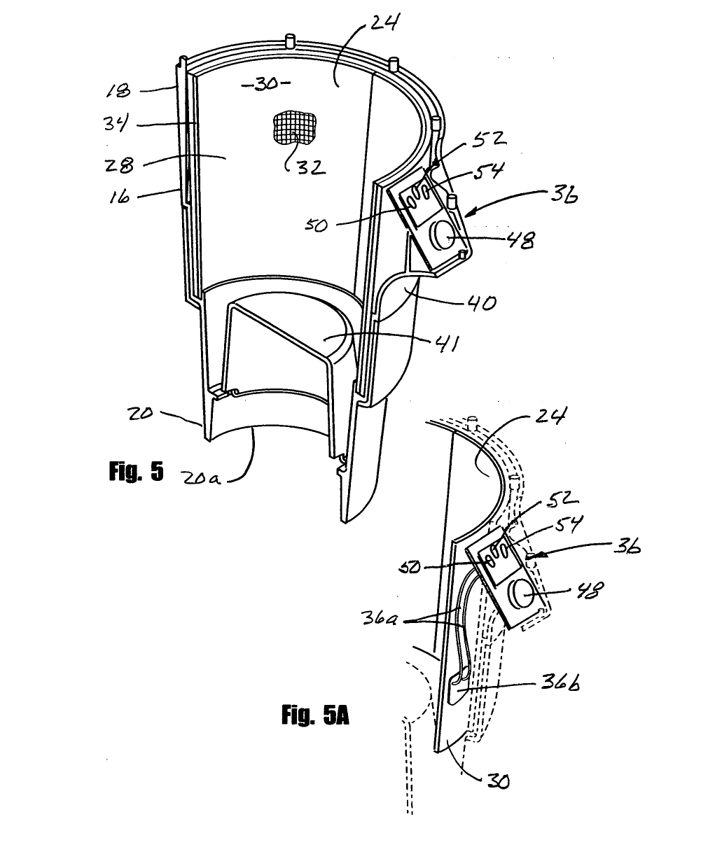

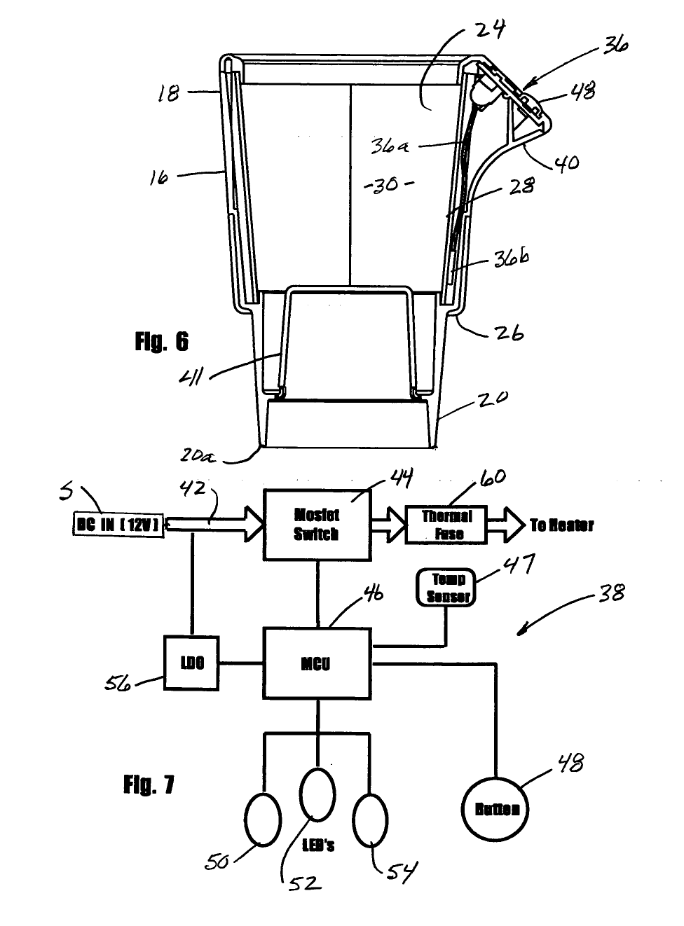

Referring to the drawings and particularly to FIGS. 1 through 4, one form of the apparatus of the invention for warming consumable liquids and for maintaining the elevated temperature of the liquid is there shown and generally designated by the numeral 14. The apparatus here comprises a housing 16 having an upper portion 18, a tapered lower portion 20, a side wall 22 defining a tapered receiving chamber 24 for receiving the container “C” and a shoulder 26 disposed between upper and lower portions 18 and 20. When the apparatus is in use, shoulder 26 engages a receptacle, such as a vehicle cup holder, so as to hold the apparatus in a stable, upright position. Lower portion 20 includes a generally planar surface 20a that permits the apparatus to rest in a stable fashion on a table, desk top and the like (See FIG. 5).

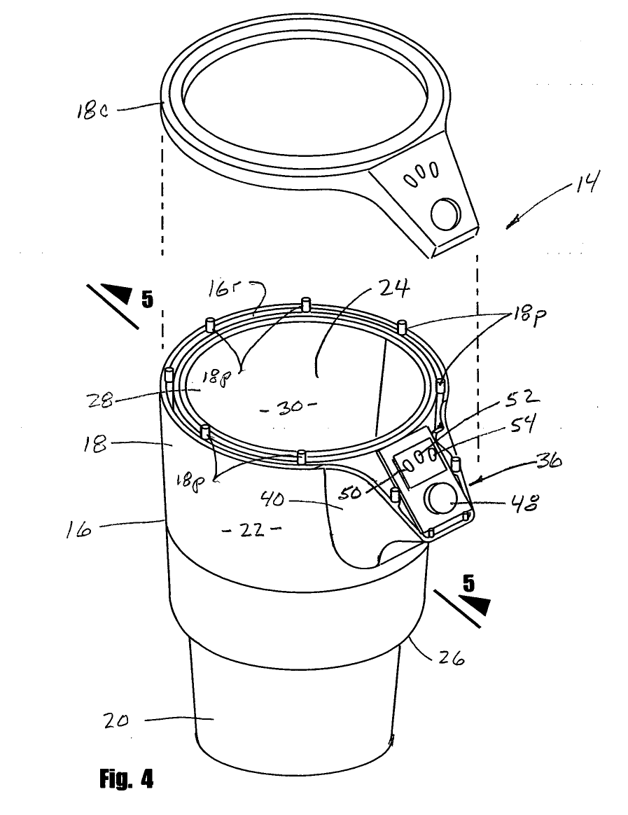

Upper portion 18 includes a cover 18c that is aligned with and affixed to the housing rim 16r by means of a plurality of circumferentially spaced, upwardly extending pins 18p that are closely received within a plurality of apertures (not shown) formed in the cover 18c (See FIG. 4).

Carried by housing 16 for controllably heating receiving chamber 24 is a specially designed electric heater assembly 28, which here comprises a generally conical shaped, flexible resistive heater member 30 that is carried by housing 16 in close proximity to tapered receiving chamber 24. Heater member 30 here comprises a silicone encapsulated wire-wound heating element 32. The silicone rubber encapsulation 34 is very flexible yet provides a water-tight environmental seal. The electric heater comprises a generally conical shaped member carried by said housing and disposed proximate said tapered receiving chamber, said generally conical shaped member having a heating element embedded therewithin. As indicated in FIG. 5 of the drawings, heater assembly 28 includes an insulating member 28a that is affixed to the outer surface of the heater member 30. Insulating member 28a here comprises a sponge rubber insulation that is formed to conform to the outer surface of the heater member.

Forming an important feature of the present invention is the controller 36 that is operably associated with the electric heater for energizing the electric heater and for selectively heating the electric heater to a selected elevated temperature and for maintaining the electric heater at the selected temperature. More particularly, controller 36 is interconnected with the electric heater in a conventional manner by means of a pair of connector wires 36a and a connector terminal 36b (FIG. 5A). Controller 36 comprises an electrical circuit 38 (FIG. 7) the character of which will presently be described. As best seen in FIG. 4, the upper portion 18 of housing 16 includes a protuberance 40 upon which the electrical circuit of the controller is mounted. The lower portion 20 of housing 16 includes a generally cup-shaped support 41 for supporting the container “C” that is mounted internally of a chamber 20a formed in the lower portion 20.

Referring particularly to FIG. 7, one form of the electrical circuitry 38 is there shown. As indicated in FIG. 7, the portable liquid warmer or coffee cup warmer of the invention is designed to operate from a 12 VDC source “S”, such as a cigarette lighter, or from a 120 VAC to 12 VDC adapter. For this purpose, the circuit includes a connector 42 for connecting the electrical circuit to the twelve-volt power source “S”.

The DC IN, or source “S” feeds to a readily commercially available metal-oxide-semiconductor field-effect transistor (MOSFET) switch 44 of a character well understood by those skilled in the art that consists of a pair of N-Channel MOSFETs in parallel as a low-side power switch. The transistor switch controls the DC power passing from the input to the heater element while a thermistor assembled in the heater assembly is monitored to determine the actual temperature. The transistors are driven with a logic level signal (e.g. 3.3 Volt) to reduce system complexity. Two transistors are used in parallel to reduce power dissipation which can be more of a problem with low gate voltage drive. The MOSFET switch 44 is available from various sources, but a MOSFET switch offered for sale by Texas Instruments of Dallas, Tex. has proven satisfactory for the present purpose.

The MOSFET switch 44 communicates with a microcontroller (MCU) 46 that provides the control and measurement features necessary to operate the device. The microcontroller 46 sequences the control signals, measures the temperature via a temperature sensor 47 and provides the user interface controls for a control button 48 and three LED indicators 50, 52 and 54. A small linear low dropout (LDO) voltage regulator 56 provides the operating power for the MCU and LEDs.

In the apparatus of the present form of the invention, the MCU 46 performs two primary control functions. The first of these is the user interface control which processes button presses by the user to select the various operating modes. The second control function is the temperature measurement and heater control function. This also includes an automatic power-down feature to de-energize the electric heater after a predetermined period of time. The MCU here includes a 16-bit analog to digital converter (ADC) for measurement of the thermistor-controlled voltage (temperature).

As depicted in FIG. 1, the LED's 50, 52 and 54, each of which is covered by a lens is in the shape of a coffee bean, are readily commercially available from sources such as the Kingbright Corporation of City Of Industry, California. The LED's function to indicate which setting is active on the cup warmer. The LED's and control button 48 are directly interfaced to the MCU and the user interface is implemented in software which executes on the MCU in a manner well understood by those skilled in the art. In the present form of the invention, LED 50 indicates the low setting while LED's 52 and 54 indicate medium and high settings, respectively. The temperature settings can be preset at any desired levels, but here are set at 125, 140 and 155 degrees Fahrenheit respectively. Sequentially pressing the control button 48 indexes the system through four modes, namely off, low heat, medium heat and high heat.

A timer disposed internally of the MCU 46 provides a periodic measurement and control update function as well as an automatic power-off timer. MCU 46, which is of a character well understood by those skilled in the art, is available from various sources, but an MCU offered by Texas Instruments under the serial number MSP430 has proven satisfactory for the present purpose.

As previously mentioned, temperature is measured at the outside of the flexible heater using the temperature sensor 47. The microcontroller compares the measured voltage to set-point operating levels to determine whether the device temperature is at the proper value. The temperature sensor is available from various sources, but a sensor offered by the Cantherm Company of Montreal, Canada has proven satisfactory.

As previously mentioned, controller 36 functions to de-energize the electric heater after it reaches a predetermined elevated temperature. For this purpose, a thermal fuse 60 is assembled in series with the flexible heater of the apparatus and is placed in contact with the heater. The thermal fuse 60 is designed to open the circuit and force the heater off should the temperature ever exceed about 183° F. (84° C.). In order to prevent melting of the plastic or combustion of internal parts of the device, fuse 60 cannot be reset and must be replaced should the over-temperature condition ever occur. Thermal fuses of various temperatures are readily commercially available and the optimal safety temperature is selected to match the particular design materials and safety requirements.

For additional safety, the controller circuit also includes the previously mentioned internal timer that provides an automatic shutoff feature that functions to de-energize the heater after the expiration of a predetermined time as, for example, approximately 30 minutes. The shutoff timer may be reset by simply pressing the control button to start another cycle.

In using the apparatus of the invention, the user first inserts the container “C” containing the consumable liquid, such as a tapered paper cup, into the tapered receiving chamber 24. In this regard, as previously mentioned, the tapered receiving chamber 24 accepts all standard cup sizes and performs equally well with various other cup sizes. With the device connected to a suitable 12 VDC or 120 VAC power source, the control button 48 is pushed to activate the device. This will cause the electric heater to heat to the low temperature of about 125 degrees Fahrenheit and will cause LED 50 to illuminate indicating that the low temperature setting has been selected. A second pushing of the control button 48 will cause the electric heater to heat to the medium temperature of about 140 degrees Fahrenheit and will cause LED 52 to illuminate indicating that the medium temperature setting has been selected.

A third pushing of the control button 48 will cause the electric heater to heat to the high temperature of about 155 degrees Fahrenheit and will cause LED 54 to illuminate indicating that the high temperature setting has been selected. A fourth pushing of the control button 48 will inactivate the device so that a new cycle can be started at the convenience of the user.

Following activation of the device, if the temperature rises above the programmed temperature settings (Low/Medium/High), the unit will automatically shut off and will reactivate once as the temperature reaches the specified level. Similarly, following activation of the device, the device will automatically deactivate after 30 minutes have expired. To reactivate the device, the user need only push the control button 48.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. An apparatus for warming liquids contained within a container and for maintaining the elevated temperature of the liquid, said apparatus comprising:
(a) a housing having an upper portion, a tapered lower portion and a side wall defining a tapered receiving chamber for receiving the container;
(b) an electric heater carried by said housing for heating said receiving chamber; and
(c) a controller comprising an electrical circuit operably associated with said electric heater for energizing said electric heater and for maintaining said receiving chamber at a selected one of a plurality of elevated temperatures.

2. The apparatus as defined in claim 1 in which said controller functions to de-energize said electric heater after said electric heater reaches a predetermined elevated temperature.

3. The apparatus as defined in claim 1 in which said controller functions to de-energize said electric heater after the expiration of a predetermined time following energization of said electric heater.

4. The apparatus as defined in claim 1 in which said electrical circuit of said controller includes a temperature sensor operably associated with said electric heater for sensing the temperature of said electric heater.

5. The apparatus as defined in claim 1 in which said controller includes a connector for connecting said electrical circuit to a twelve-volt power source.

6. The apparatus as defined in claim 1 in which said housing includes a shoulder located between said upper and lower portions.

7. The apparatus as defined in claim 1 in which said upper portion of said housing includes a protuberance, said electrical circuit of said controller being mounted on said protuberance.

8. The apparatus as defined in claim 1 in which said electric heater comprises a generally conical shaped member carried by said housing and disposed proximate said tapered receiving chamber, said generally conical shaped member having a heating element embedded therewithin.

9. The apparatus as defined in claim 1 in which said electrical circuit of said controller further includes a plurality of light emitting diodes for indicating the temperature of said heating element.

10. An apparatus for warming liquids contained within a container and for maintaining the elevated temperature of the liquid, said apparatus comprising:
(a) housing having an upper portion, a tapered lower portion, a side wall defining a tapered receiving chamber for receiving the container and a shoulder disposed between said upper and lower portions;
(b) an electric heater carried by said housing for heating said receiving chamber, said electric heater comprising a generally conical shaped member carried by said housing and disposed proximate said tapered receiving chamber, said generally conical shaped member having a heating element embedded there within; and
(c) a controller operably associated with said electric heater for energizing said electric heater and for selectively heating said electric heater to a first elevated temperature, to a second elevated temperature greater than said first elevated temperature and to a third elevated temperature intermediate said first and second elevated temperatures, said controller comprising an electrical circuit, including a temperature sensor that is operably associated with said electric heater for sensing the temperature of said electric heater.

11. The apparatus as defined in claim 10 in which said upper portion of said housing includes a protuberance, said electrical circuit of said controller being mounted on said protuberance.

12. The apparatus as defined in claim 10 in which said lower portion of said housing includes an internally mounted, generally cup-shaped support for supporting the container.

13. The apparatus as defined in claim 10 in which said controller functions to de-energize said electric heater after said electric heater reaches a predetermined elevated temperature.

14. The apparatus as defined in claim 10 in which said controller functions to de-energize said electric heater after the expiration of a predetermined time following energization of said electric heater.

15. The apparatus as defined in claim 10 in which said controller includes a connector for connecting said electrical circuit to a twelve-volt power source.

16. The apparatus as defined in claim 10 in which said upper portion of said housing includes a protuberance, said electrical circuit of said controller being mounted on said protuberance.

17. The apparatus as defined in claim 10 in which said electrical circuit of said controller further comprises a plurality of light emitting diodes for indicating the temperature of said electric heater.

18. An apparatus for warming liquids contained within a container and for maintaining the elevated temperature of the liquid, said apparatus comprising:
(a) housing having an upper portion having a protuberance, a tapered lower portion having an internally mounted, generally cup-shaped support for supporting the container, a side wall defining a tapered receiving chamber for receiving the container, and a shoulder disposed between said upper and lower portions;
(b) an electric heater carried by said housing for heating said receiving chamber, said electric heater comprising a generally conical shaped member carried by said housing and disposed proximate said tapered receiving chamber, said generally conical shaped member having a heating element embedded there within; and
(c) a controller operably associated with said electric heater for energizing said electric heater and for selectively heating said electric heater to a first elevated temperature of about 125 degrees Fahrenheit to a second elevated temperature of about 140 degrees Fahrenheit and to a third elevated temperature of about 155 degrees Fahrenheit, said controller comprising an electrical circuit mounted on said protuberance and including a connector for connecting said electrical circuit to a twelve-volt power source, said circuit including:
(a) a temperature sensor that is operably associated with said electric heater for sensing the temperature of said electric heater, and
(b) a plurality of light emitting diodes for indicating the temperature of said electric heater.

19. The apparatus as defined in claim 18 in which said controller functions to de-energize said electric heater after said electric heater reaches a predetermined elevated temperature.

20. The apparatus as defined in claim 18 in which said controller functions to de-energize said electric heater after the expiration of a predetermined time following energization of said electric heater.
